(19) United States
(12) Patent Application Publication
(10) Pub. No.: US 2017/0117741 A1
(43) Pub. Date: Apr. 27, 2017

(54) APPARATUS AND METHOD FOR REDUCING NOISE OF A WIRELESS CHARGING DEVICE

(71) Applicants: HYUNDAI MOTOR COMPANY, SEOUL (KR); KIA MOTORS CORPORATION, SEOUL (KR)

(72) Inventors: Jeong Kee LEE, Seoul (KR); Kil Sang CHO, Suwon-si (KR); Wung Chul CHUNG, Seongnam-si (KR)

(73) Assignees: HYUNDAI MOTOR COMPANY, SEOUL (KR); KIA MOTORS CORPORATION, SEOUL (KR)

(21) Appl. No.: 15/220,576

(22) Filed: Jul. 27, 2016

(30) Foreign Application Priority Data
Oct. 21, 2015 (KR) 10-2015-0146673

(51) Int. Cl. H02J 7/02; H02J 50/10; H02J 50/80; H02J 50/60; H02J 7/04; H02J 50/90

(52) U.S. Cl. CPC H02J 7/025; H02J 7/045; H02J 50/90; H02J 50/80; H02J 50/60; H02J 50/10

(57) ABSTRACT

The present disclosure relates to an apparatus and a method for reducing noise generated in a wireless charging device. A method for reducing noise in a wireless charging device may include: outputting a pulse of a first voltage to a first coil in a first period and monitoring a variation in a response current according to feedback of the output pulse to check whether an object is located on the wireless charging device; checking whether communication with the object is possible when the object is located on the wireless charging device; and, when communication with the object is not possible, outputting a pulse of a second voltage lower than the first voltage to the first coil in the first period to check whether the object is located on the wireless charging device. Accordingly, noise generated in the wireless charging device can be reduced.

### RELATED APPLICATION

The present application claims the benefit of Korean Patent Application No. 10-2015-0146673, filed on Oct. 21, 2015, the entirety of which is hereby incorporated by reference.

### BACKGROUND

Field of the Disclosure

The present disclosure relates to an apparatus and a method for reducing noise generated in a wireless charging device of a terminal.

Discussion of the Related Art

Portable terminals such as cellular phones and notebook computers include a battery cell storing power and a circuit for charging and discharging the battery cell. The battery cell of a terminal needs to be provided with power from an external charger to be charged.

Methods for electrically connecting the battery cell and a charging device for charging the battery cell with power include a terminal supply method which converts commercial power supplied thereto into a voltage and current corresponding to the battery cell and provides electric energy to the battery cell through a terminal of the battery cell. The terminal supply method requires use of a physical cable or wire. Accordingly, when a lot of apparatuses employing the terminal supply method are used, many cables occupy a considerable space and thus the cables are difficult to arrange and are unclean. Furthermore, the terminal supply method may cause instantaneous discharge due to a potential difference between terminals, damage and outbreak of fire due to foreign substances, natural discharge, battery pack lifespan and performance deterioration and the like.

To address the aforementioned problems, a charging system using wireless power transmission (referred to as a wireless power charging system) and control methods therefor have been recently suggested. In the past, demand for the wireless power charging system was low since the wireless power charging system was not provided by default to cellular phones and thus users needed to purchase a wireless charging receiver accessory. However, it is expected that the number of wireless charging system users will increase and cellular phone manufacturers will preload a wireless charging function in cellular phones.

While such a wireless power charging system can be used while being placed on a desk or table, the wireless power charging system may be developed for vehicles and used in vehicles. The wireless power charging system installed in a vehicle may be provided in the form of a holder which can fix and hold a wireless power receiver easily and stably. In this case, however, when a terminal or an object made of steel, which is not applied to the wireless power charging system, is placed on a wireless charging device installed in a vehicle, a ticking noise is continuously generated.

Accordingly, there is a need for a method for reducing noise generated when a terminal or an object made of steel, which is not applied to the wireless power charging system, is placed on the wireless charging device to solve problems of inconvenience of consumers.

### SUMMARY

An object of the present disclosure devised to address the problem lies in an apparatus and a method for reducing noise generated in a wireless charging device applied to a vehicle.

Specifically, the present disclosure provides an apparatus and a method for reducing noise generated when a terminal or an object made of steel, which is not applied to a wireless power charging system, is located on a wireless charging device provided to a vehicle.

The technical problems addressed by the present disclosure are not limited to the above technical problems and those skilled in the art may understand other technical problems from the following description.

In an aspect of the present disclosure, a method for reducing noise in a wireless charging device includes: outputting a pulse of a first voltage to a first coil in a first period and monitoring a variation in a response current according to feedback of the output pulse to check whether an object is located on the wireless charging device; checking whether communication with the object is possible when the object is located on the wireless charging device; and, when communication with the object is not possible, outputting a pulse of a second voltage lower than the first voltage to the first coil in the first period to check whether the object is located on the wireless charging device.

The method may further include transferring power to the object in a second period when communication with the object is possible.

The response current may correspond to an output current of a feedback reception circuit of the wireless charging device.

The communication may be performed based on one of WPC or PMA standards.

The checking of whether communication with the object is possible may include checking whether a response signal to an identification signal transmitted to identify whether the object is a terminal applicable to one of the WPC or PMA standards is received from the object within a predetermined time.

The checking of whether communication with the object is possible may include checking whether the response signal is received in a third period.

In another aspect of the present disclosure, wireless charging device includes: a controller for controlling a period and voltage of a pulse output to a first coil; an object recognition unit for checking whether an object is located on the wireless charging device by monitoring a variation in a response current according to feedback of the output pulse; and a communication unit performing communication with the object, wherein the controller controls a second voltage lower than a first voltage of the pulse output to the first coil to be output when communication with the object is impossible.

The controller may check whether communication with the object is possible by checking whether a response signal is received within a predetermined time.

The wireless charging device may further include an inductive power transmitter for transferring power to the object in a second period.

The response current may correspond to an output current of a feedback reception circuit of the wireless charging device.

The communication may be performed based on one of WPC or PMA standards.

The controller may check whether communication with the object is possible by receiving a response signal to an identification signal transmitted by the communication unit to identify whether the object is a terminal applicable to one of the WPC or PMA standards from the object within a predetermined time.

Forms of the apparatus and method for reducing noise of a wireless charging device described in the present disclosure have the following advantages.

Firstly, forms of the present disclosure can decrease noise generated when a terminal or an object made of steel, which is not applied to the wireless power charging system, is placed on the wireless charging device, thereby reducing user stress due to the noise.

Secondly, forms of the present disclosure reduce driver stress due to noise during driving by installing the wireless charging device in the vehicle.

Thirdly, it is possible to reduce power consumption for the wireless charging device by setting two output voltage levels of the wireless charging device and using a lower voltage level.

The effects of the present disclosure are not limited to the above-described effects and other effects which are not described herein will become apparent to those skilled in the art from the following description.

### BRIEF DESCRIPTION OF THE DRAWINGS

The accompanying drawings, which are included to provide a further understanding of the disclosure and are incorporated in and constitute a part of this application, illustrate form(s) of the disclosure and together with the description serve to explain the principle of the disclosure. In the drawings:

FIG. 1 is a flowchart illustrating a wireless power transmission method;

FIG. 2 illustrates a wireless power transmission system;

FIG. 3 is a state transition diagram illustrating a wireless power transmission procedure;

FIG. 4 is a state transition diagram illustrating the wireless power transmission procedure shown in FIG. 3;

FIG. 5 is a flowchart illustrating a process of setting two output voltages and applying the output voltages to the wireless power transmission procedure;

FIG. 6 illustrates the process of FIG. 5 in a predetermined period with time; and

FIG. 7 is a block diagram of a wireless charging device for reducing noise.

### DETAILED DESCRIPTION

Reference will now be made in detail to forms of the present disclosure, examples of which are illustrated in the accompanying drawings. Although the suffix “module” or “unit” are used for constituent elements described in the following description, this is intended only for ease of description of the specification.

In the following description, a detailed description of known functions and configurations incorporated herein will be omitted when it may obscure the subject matter of the present disclosure.

In described forms, a wireless power transmitter, a wireless power transmission device, a transmission end, a transmitter, a transmission device, transmission side, a wireless charging device and the like can be used interchangeably to represent a wireless power transmission apparatus in a wireless power charging system for convenience of description. In addition, a wireless power reception apparatus, a wireless power receiver, a wireless power reception device, a reception terminal, a reception side, a reception device and the like can be interchangeably used to represent an apparatus for receiving wireless power from the wireless power transmission apparatus for convenience of description.

A wireless charging device may be configured in the form of a pad, a holder, an access point (AP), a small base station, a stand, a ceiling-embedded type, a wall-hanging type and the like. A single transmitter may transmit power to a plurality of wireless power reception apparatuses. To this end, a terminal may include at least one wireless power transfer means. Here, the wireless power transfer means may use various wireless power transfer standards based on an electromagnetic induction method of charging power using electromagnetic induction which generates magnetic fields in a coil of a power transmission end to induce electricity in a coil of a reception end under the influence of the magnetic fields. Here, the wireless power transfer means can include an electromagnetic induction wireless charging technology defined in WPC (Wireless Power Consortium) and PMA (Power Matters Alliance), which are wireless charging technology standardization organizations.

A terminal can be used for small electronic devices such as a mobile phone, a smartphone, a laptop computer, a digital broadcast terminal, a PDA (Personal Digital Assistant), a PMP (Portable Multimedia Player), a navigation device, an MP3 player, a power toothbrush, an RFID, a lighting device, a remote controller and a float. However, the terminal is not limited thereto and can be any device having a battery that can be charged through a wireless power reception means.

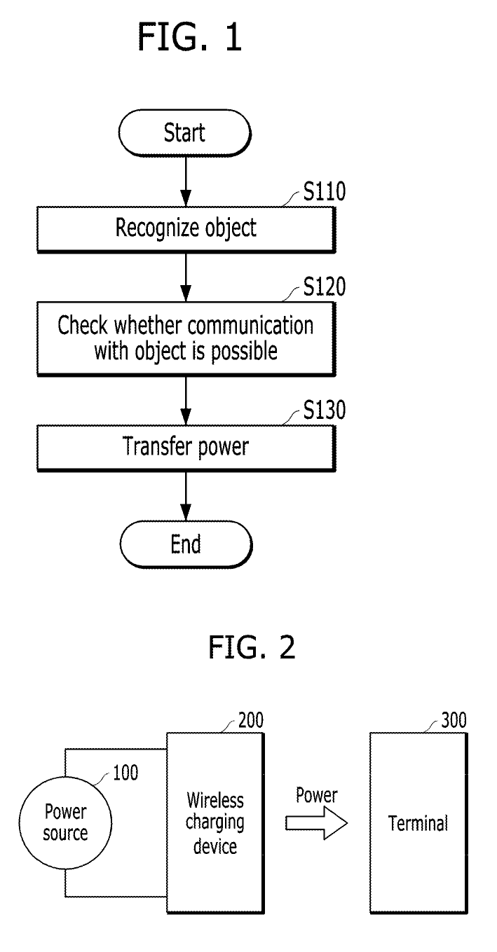

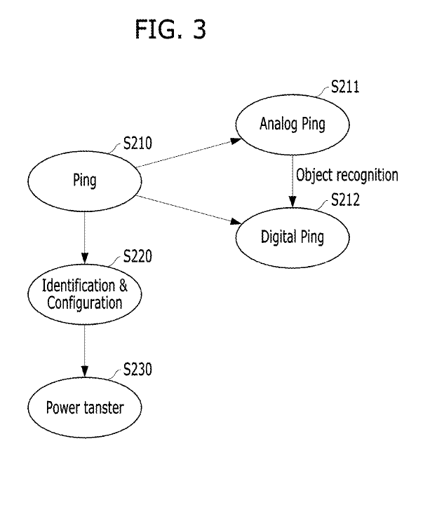

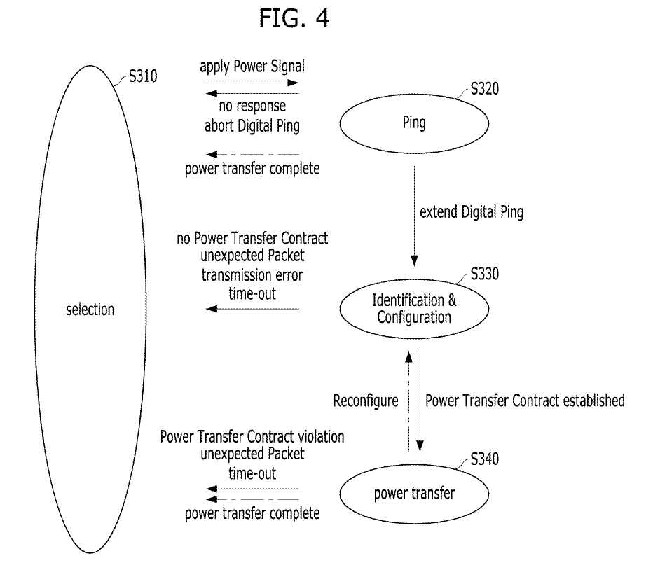

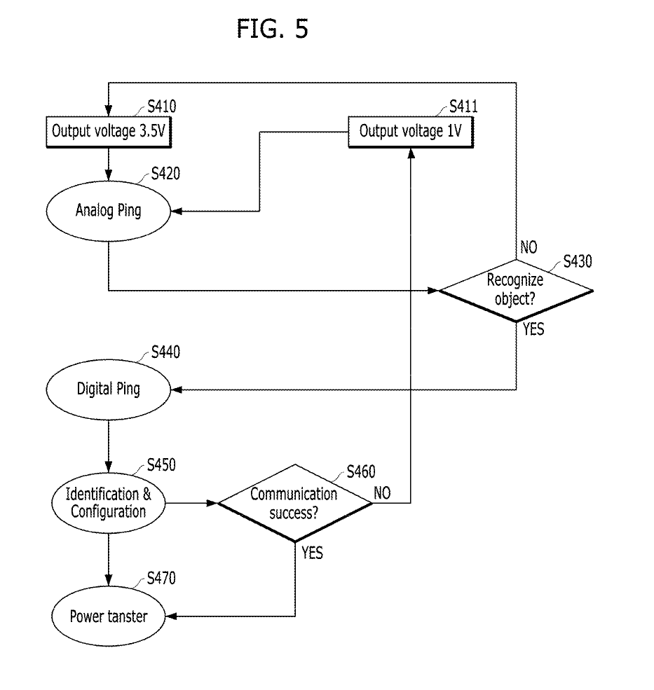

A wireless power transfer method will now be described with reference to FIGS. 1 and 2 and problems of conventional wireless power transfer methods will be examined with reference to FIGS. 3 and 4 which are state transition diagrams illustrating a wireless power transfer procedure. Then, a method and an apparatus for addressing the problems will be described with reference to FIGS. 5, 6 and 7.

FIG. 1 is a flowchart illustrating a wireless power transfer method.

Referring to FIG. 1, a method for transferring wireless power from a wireless charging device to a terminal can be divided into three steps.

The wireless charging device checks whether an object is positioned on a charging pad thereof (S110).

Upon recognition of the object placed on the charging pad, the wireless charging device checks whether communication with the object is possible in order to identify whether the object is a terminal capable of receiving power wirelessly (S120).

When the wireless charging device identifies the object as a terminal capable of receiving power by communicating with the object, the wireless charging device transfers power (S130).

A description will be given of a wireless power transfer system supporting electromagnetic induction with reference to FIG. 2.

FIG. 2 illustrates a configuration of a wireless power transfer system.

Referring to FIG. 2, the wireless power transfer system may include a power source 100, a wireless charging device 200 and a terminal 300. While the power source 100 may be included in the wireless charging device 200 in an embodiment, the present invention is not limited thereto.

The wireless charging device 200 and the terminal 300 may exchange control signals or information through in-band communication. Here, in-band communication may be performed using pulse width modulation, frequency modulation and the like. For example, the terminal 300 can generate a feedback signal by switching on/off a current induced through a reception coil in a predetermined pattern to transmit various control signals and information to the wireless charging device 200.

For example, information transmitted by the terminal 300 may be received power strength information in the case of WPC standard. Here, the wireless charging device 200 can calculate charging efficiency or power transfer efficiency on the basis of the received power strength information.

A description will be given of a wireless power transfer procedure with reference to FIG. 3.

FIG. 3 is a state transition diagram for explaining a wireless power transfer procedure.

Referring to FIG. 3, power transfer from the wireless charging device 200 to the terminal 300 can be divided into ping phase S210, an identification and configuration phase S220 and a power transfer phase S230. The ping phase S210 can be divided into an analog ping phase S211 and a digital ping phase S212.

The state transition diagram of FIG. 3 corresponds to the object recognition step S110, the step S120 of checking whether communication with an object is possible and the power transfer step S130.

The wireless charging device transmits an analog ping signal in order to check whether an object is located on the charging pad thereof (s211). For example, the analog ping signal can be generated through the wireless charging device by outputting a predetermined voltage to a first coil. The wireless charging device can check whether the object is located thereon by monitoring a response current variation according to feedback of output pulses.

When the wireless charging device recognizes that the object is located on the charging pad thereof, the wireless charging device transmits a digital ping signal to the object in order to check whether the object is a terminal capable of receiving power wirelessly (S212). The digital ping signal may be a signal defined in WPC (Wireless Power Consortium) or PMA (Power Matters Alliance), which are wireless charging technology standardization organizations.

When the object transmits a response signal to the digital ping signal to the wireless charging device and the wireless charging device receives the response signal within a predetermined time, the wireless charging device can check whether the object is a terminal capable of receiving power wirelessly.

The response signal may be a signal defined in WPC or PMA and may include data (e.g. identification information of a terminal to which the wireless charging device is applicable and/or specification information about power transfer) that the wireless charging device desires. That is, the wireless charging device can identify the object as a terminal capable of receiving power according to the response signal (S220).

When the wireless charging device has passed through the ping phase S210 and the identification and configuration phase S220, the wireless charging device transfers power to the terminal (S230).

FIG. 4 is a state transition diagram for explaining the wireless power transfer procedure shown in FIG. 3.

Referring to FIG. 4, power transfer from the wireless charging device to the terminal may be divided into a selection phase S310, a ping phase S320, an identification and configuration phase S330 and a power transfer phase S340.

The selection phase S310 may be performed when a specific error or a specific event is detected when power transfer is started or while power transfer is maintained. The specific error and the specific event will be described later. During the selection phase S310, the wireless charging device can monitor presence of an object on the interface surface.

Upon detection of presence of the object on the interface surface, the procedure can progress to the ping phase S320. During the selection phase S310, the wireless charging device transmits an analog ping signal with a very short pulse and can detect presence of an object in an active area on the interface surface on the basis of a current variation of a transmission coil. Analog ping may be periodically executed, for example, at an interval of 400 msec.

Upon detection of an object during the ping phase S320, the wireless charging device transmits a digital ping signal. When the wireless charging device does not receive a response signal to the digital ping signal from the terminal during the ping phase S320, the procedure can progress to the selection phase S310. In addition, when the wireless charging device receives, from the terminal, a signal indicating completion of power transfer, that is, a charging completion signal during the ping phase S320, the procedure can progress to the selection phase S310.

Upon completion of the ping phase S320, the procedure can progress to the identification and configuration phase S330 for identifying terminal and collecting terminal configuration and state information. When an unexpected packet is received, an expected packet is not received for a predefined time (time out), a packet transmission error is present or no power transfer contract is set during the identification and configuration phase S330, the procedure can return to the selection phase S310.

Upon completion of identification and configuration with respect to the terminal, the procedure can progress to the power transfer phase S340 for transferring wireless power. When an unexpected packet is received, an expected packet is not received for a predefined time (time out), power transfer contract violation occurs or charging is completed during the power transfer phase S340, the procedure can return to the selection phase S310.

In addition, when the wireless charging device needs to reconstruct the power transfer contract according to wireless charging device state variation during the power transfer phase S340, the procedure can progress to the identification and configuration phase S330.

The power transfer contract may be set on the basis of state and characteristic information of the wireless charging device and the terminal. For example, wireless charging device state information may include information about maximum transferable power and information about the maximum number of acceptable terminals and the terminal state information may include information about required power.

When a terminal or an object made of a steel material, which is not applied to the wireless power charging system, is placed on the wireless charging device, noise can be generated.

Even if it is detected that the object is not terminal or an object made of a steel material, which is not applied to the wireless power charging system, during the digital ping phase, the analog ping phase and the digital ping phase are repeated periodically. That is, noise is periodically generated as the analog ping phase and the digital ping phase are repeated.

The noise is caused by vibration of a ceramic capacitor included in the wireless charging device according to inverse piezoelectric effect during charging and discharging of the ceramic capacitor and vibration of a coil due to generation of a gap in the coil according to Lorentz force as current flows through the coil.

In other words, vibration of the capacitor and vibration of the coil, which correspond to the principal cause of generation of the noise, are caused by repeated execution of the analog ping phase and the digital ping phase in a predetermined period even when the wireless charging device detects an object which is not a terminal or a steel object which is not applied to the wireless power charging system.

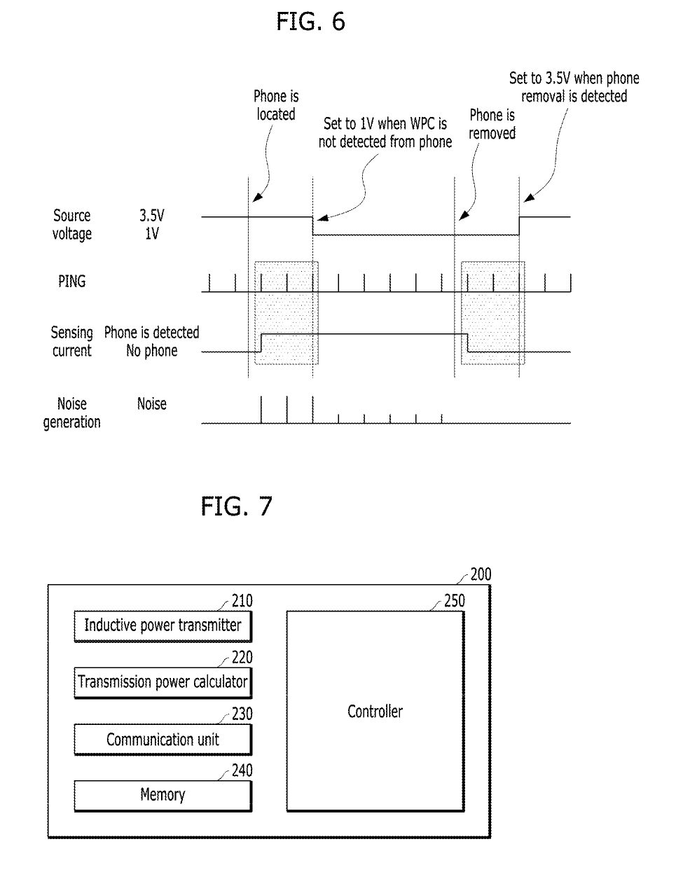

A description will be given of a method for reducing noise with reference to FIGS. 5 and 6.

FIG. 5 is a flowchart illustrating a process of setting two output voltages and applying the output voltages in the wireless power transfer procedure.

Referring to FIG. 5, the ping phases are executed with output voltages of 3.5V and 1V.

Specifically, analog ping is executed (S420) with the output voltage of 3.5V (S410) and whether an object is located on the wireless charging device is checked (S430). Upon recognition of the object located on the wireless charging device (“Yes” of S430), whether communication is available between the wireless charging device and the object is checked during identification and configuration phase 5450 (S460).

When communication between the wireless charging device and the object is impossible (“No” of S460) although it is confirmed that the object is located on the wireless charging device through analog ping, analog ping is executed with the output voltage of 1V (S411).

When communication between the wireless charging device and the object is impossible although it is confirmed that the object is located on the wireless charging device through analog ping, it is possible to reduce vibration of the capacitor and vibration of the coil corresponding to the principal cause of generation of noise by decreasing the output voltage. Vibration of the capacitor is caused by inverse piezoelectric effect and a degree of piezoelectric deformation decreases as a potential difference decreases, and thus the intensity of vibration of the capacitor is reduced. In addition, the intensity of magnetic fields decreases as the potential difference decreases and thus vibration of the coil is reduced.

FIG. 6 illustrates the process of FIG. 5 with time in a predetermined period.

Referring to FIG. 6, when a phone (terminal) or an object made of a steel material, which is not applied to the wireless power charging system, is located on the wireless charging device, the effect of reducing noise generated in the wireless charging device by setting two output voltages can be checked in a period in which a ping is executed.

The ping is repeatedly executed in a predetermined period in order to detect an object placed on the wireless charging device and to check whether power can be transferred to the object.

It can be confirmed that an object (terminal) is located on the wireless charging device from the magnitude of monitored current.

In addition, it can be confirmed that the output voltage is reduced to 1V since a response signal according to predetermined wireless power transfer standards is not received from the terminal located on the wireless charging device after a predetermined time elapses from monitoring of the output current according to the ping. Furthermore, it can be confirmed that the noise level is decreased according to output voltage reduction.

The noise reduction effect is shown in the following table.

TABLE 1

| | Terminal manufacturers | | | | | |
|---|---|---|---|---|---|---|
| | S company | | L company | | A company | |
| Classification | Model 1 | Model 2 | Model 3 | Model 4 | Model 5 | Model 6 |
| Conventional | 33/ | 27/ | 45/ | 43/ | 38/ | 38/ |
| (proximate/ | 22 | 25 | 25 | 23 | 26 | 26 |
| seating) | | | | | | |
| Improved | 25 (8▾)/ | 25 (2▾)/ | 31 (14▾)/ | 29 (14▾)/ | 27 (11▾)/ | 27 (11▾)/ |
| (proximate/ | 21 (1▾) | 21 (4▾) | 21 (4▾) | 22 (1▾) | 21 (5▾) | 21 (5▾) |
| seating) | | | | | | |

Proximate measurement and seating measurement may be performed to measure noise. Proximate measurement is a method of measuring noise with the wireless charging device close to a user's ear, and seating measurement is a method of measuring noise that a driver hears when seated in a correct position on a driver's seat.

When the two output voltages are applied, noise is reduced by up to 14 dB, compared to the conventional wireless charging device, in proximate measurement.

Movement of hands of a clock and sound of stepping on snow correspond to 25 dB and sound of stream or a birdcall corresponds to 25 to 40 dB. Considering that noise of 3 dB may be actually felt as double, it can be confirmed from the table that noise is reduced compared to the conventional wireless charging device.

FIG. 7 illustrates a configuration of an apparatus for reducing noise of the wireless charging device.

Referring to FIG. 7, the wireless charging device 200 may include an inductive power transmitter 210, a transmission power calculator 220, a communication unit 230, a memory 240 and a controller 250.

The components shown in FIG. 7 are not essential and thus a wireless charging device having a different number of components may be implemented.

A detailed description will be given of the aforementioned components.

The inductive power transmitter 210 can perform ping signal transmission and wireless power transfer based on wireless communication standards.

The transmission power calculator 220 can measure the level of power applied to a transmission coil of the inductive power transmitter 210 when wireless transmission power is stabilized according to power control through in-band signaling in the power transfer phase.

For example, wireless transmission power can be determined to be stabilized when a wireless transmission power variation is less than a predetermined reference value. Alternatively, wireless transmission power may be determined to be stabilized when power control is performed within a predetermined range for a predetermined time.

The communication unit 230 transmits/receives signals and data to/from a terminal constituting the wireless power charging system. That is, the communication unit 230 can transmit or receive a specific control signal and status information through in-band communication.

The memory 240 is a space and/or a region storing a predetermined program code for controlling the overall operation of the wireless charging device 200 and data input/output when operation according to the program code is performed and is provided in the form of an EEPROM (Electrically Erasable and Programmable Read Only Memory), a FM (Flash Memory), a hard disk drive or the like.

The controller 250 can perform data processing and calculations for controlling the overall operation of the wireless charging device 200.

In one embodiment, the controller 250 can detect an object according to analog ping from the output current of a feedback reception circuit of the wireless charging device. The feedback reception circuit of the wireless charging device can monitor a response signal to ping signal transmission from the inductive power transmitter 210 based on wireless power transfer communication standards. A buck IC may be used as the feedback reception circuit.

In addition, the controller 250 can identify terminal applied to predetermined wireless power transfer communication standards by checking whether communication with the terminal is available according to digital ping signal transmission. When the terminal is a phone (terminal) or a steel object which is not applied to the wireless power charging system, the controller can control the output voltage of the inductive power transmitter 210.

In some forms, the method described above may be implemented as a program executed in a computer and stored in a computer-readable recording medium. Examples of the processor-readable recording medium include a ROM, a RAM, a CD-ROM, a magnetic tape, a floppy disk, optical data storage, and a carrier wave (e.g., data transmission over the Internet).

The computer-readable recording medium may be distributed to computer systems connected through a computer communication network, stored and executed as code readable in a distributed manner. In addition, function programs, code and code segments for implementing the aforementioned method can be easily inferred by programmers in the technical field of the embodiments.

Although exemplary aspects of the present disclosure have been described for illustrative purposes, those skilled in the art will appreciate that various modifications, additions and substitutions are possible, without departing from essential characteristics of the invention. Thus, forms disclosed herein are only exemplary and not to be considered as a limitation of the disclosure.

What is claimed is:

1. A method for reducing noise in a wireless charging device, comprising:
outputting a pulse of a first voltage to a first coil in a first period and monitoring a variation in a response current according to feedback of the output pulse to check whether an object is located on the wireless charging device;
checking whether communication with the object is possible when the object is located on the wireless charging device; and
when communication with the object is not possible, outputting a pulse of a second voltage lower than the first voltage to the first coil in the first period to check whether the object is located on the wireless charging device.

2. The method according to claim 1, further comprising transferring power to the object in a second period when communication with the object is possible.

3. The method according to claim 1, wherein the response current corresponds to an output current of a feedback reception circuit of the wireless charging device.

4. The method according to claim 1, wherein the communication is performed based on one of Wireless Power Consortium (WPC) or Power Matters Alliance (PMA) standards.

5. The method according to claim 4, wherein the checking of whether communication with the object is possible comprises checking whether a response signal to an identification signal transmitted to identify whether the object is a terminal applicable to one of the WPC or PMA standards is received from the object within a predetermined time.

6. The method according to claim 5, wherein the checking of whether communication with the object is possible comprises checking whether the response signal is received in a third period.

7. A wireless charging device, comprising:
a controller configured to control a period and voltage of a pulse output to a first coil;
an object recognition unit configured to check whether an object is located on the wireless charging device by monitoring a variation in a response current according to feedback of the output pulse; and
a communication unit configured to perform communication with the object,
wherein the controller is configured to control a second voltage lower than a first voltage of the pulse output to the first coil to be output when communication with the object is impossible.

8. The wireless charging device of claim 7, wherein the controller is configured to check whether communication with the object is possible by checking whether a response signal is received within a predetermined time.

9. The wireless charging device of claim 7, further comprising an inductive power transmitter configured to transfer power to the object in a second period.

10. The wireless charging device of claim 7, wherein the response current corresponds to an output current of a feedback reception circuit of the wireless charging device.

11. The wireless charging device of claim 7, wherein the communication is performed based on one of Wireless Power Consortium (WPC) or Power Matters Alliance (PMA) standards.

12. The wireless charging device according to claim 7, wherein the controller configured to check whether communication with the object is possible by receiving a response signal to an identification signal transmitted by the communication unit to identify whether the object is a terminal applicable to one of the WPC and PMA standards from the object within a predetermined time.

13. A computer readable recording medium storing a program for executing the method according to one of claim 1.
